(19) United States
(12) Patent Application Publication
(10) Pub. No.: US 2026/0330200 A1
(43) Pub. Date: Oct. 22, 2026

(54) ARRAY SYSTEM FOR SPIKING NEURAL NETWORK AND OPERATING METHOD OF ARRAY SYSTEM

(71) Applicants: SAMSUNG ELECTRONICS CO., LTD., Suwon-si (KR); SEOUL NATIONAL UNIVERSITY R&DB FOUNDATION, Seoul (KR)

(72) Inventors: MINSIK YOON, Seoul (KR); SangBum KIM, Seoul (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/394,117

(22) Filed: Nov. 19, 2025

(30) Foreign Application Priority Data
Apr. 17, 2025 (KR) 10-2025-0050471

(51) Int. Cl. G06N 3/049; G06N 3/047

(52) U.S. Cl. CPC G06N 3/049; G06N 3/047

(57) ABSTRACT

There is provided an array system including a first pulse generator configured to generate a pulse of a pre-synaptic neuron among spiking neurons of a spiking neural network (SNN), a first synaptic array including first synaptic elements configured to process a first signal of the pre-synaptic neuron and based on the pulse, a second synaptic array including second synaptic elements configured to store a gradient transferred from a post-synaptic neuron among the spiking neurons, and a peripheral circuit block configured to generate a spike trace of the gradient and changes to the gradient over time based on the pulse, and to train the SNN by a pseudo-derivative value of the gradient.

### CROSS-REFERENCE TO RELATED APPLICATION

This application claims priority from Korean Patent Application No. 10-2025-0050471, filed on Apr. 17, 2025, in the Korean Intellectual Property Office, the disclosure of which is incorporated herein by reference in its entirety.

### BACKGROUND

### 1.Field

Methods and apparatuses consistent with example embodiments relate to an array system for a spiking neural network (SNN) and an operating method of an array system.

### 2.Description of the Related Art

SNNs may refer to neural networks in which neurons of a neural network model communicate through a sequence of spikes. The SNNs are networks in which spikes are units of information, and information may be propagated through a network of neurons and synapses. The SNNs, unlike deep learning networks such as multi-layer perceptron (MLP), a recurrent neural network (RNN), and a convolutional neural network (CNN) that exchange tensors or floats, may exchange discrete information about whether a spike has occurred in a specific neuron at a specific time.

### SUMMARY

One or more example embodiments may address at least the above problems and/or disadvantages and other disadvantages not described above. Also, the example embodiments are not required to overcome the disadvantages described above, and an example embodiment may not overcome any of the problems described above.

There is provided an array system including a first pulse generator configured to generate a pulse of a pre-synaptic neuron among spiking neurons of a spiking neural network (SNN), a first synaptic array including first synaptic elements configured to process a first signal of the pre-synaptic neuron and based on the pulse, a second synaptic array including second synaptic elements configured to store a gradient transferred from a post-synaptic neuron among the spiking neurons, and a peripheral circuit block configured to generate a spike trace of the gradient and changes to the gradient over time based on the pulse, and to train the SNN by a pseudo-derivative value of the gradient.

The first synaptic array may be configured to input a current value, based on weights stored in the first synaptic elements, to the post-synaptic neuron by the pulse.

The first synaptic array may be updated at an end of a learning episode.

The second synaptic array may be configured to transfer the gradient stored in the second synaptic elements to the first synaptic elements at an end of a learning episode.

The second synaptic array may be configured to initialize, after transferring the gradient to the first synaptic elements, a value of the gradient stored in the second synaptic elements.

The first synaptic array and the second synaptic array may include a same size and are configured to operate using spikes output from at least a same spiking neuron of the spiking neurons.

The peripheral circuit block may be further configured to at least one of: update the second synaptic array at each of a plurality of time steps, and update the second synaptic array in response to a learning signal transferred through a backward pass.

The peripheral circuit block may be further configured to calculate an eligible trace value of an outer product between the first signal of the pre-synaptic neuron and a second signal of the post-synaptic neuron, and to train the SNN based on the eligible trace value.

The peripheral circuit block may be further configured to calculate the eligible trace value by a product between a spike trace value, storing activation information of the pre-synaptic neuron, and the pseudo-derivative value of the gradient, and the pseudo-derivative value of the gradient is obtained by differentiating the second signal with a membrane potential value accumulated in the post-synaptic neuron.

The peripheral circuit block may be further configured to convert, to a converted first signal and a converted second signal respectively, the first signal and the second signal using stochastic pulses, and to update the second synaptic array according to whether there is a pulse coincidence between the converted first signal and the converted second signal.

The peripheral circuit block may be further configured to update the second synaptic array by switching based on a product between a learning signal, of the post-synaptic neuron, and the pseudo-derivative value.

The peripheral circuit block may include at least one of: a second pulse generator configured to generate a stochastic pulse in updating the gradient in the second synaptic elements, a spike trace circuit configured to accumulate the first signal, in a form of a voltage, and to generate the spike trace as leakage of the first signal, and a pseudo-derivative circuit configured to implement the pseudo-derivative value, as based on the membrane potential value accumulated in the post-synaptic neuron, in a form of a step function.

The second pulse generator may include: a random number generator configured to generate a random number, and a first comparator configured to compare the random number with a voltage value stored in the second synaptic array, and based on determining that the voltage value stored in the second synaptic array is greater than the random number, the stochastic pulse may be generated.

The second pulse generator may be configured to convert the spike trace and a product, of the pseudo-derivative value and a learning signal, into the stochastic pulse.

The spike trace circuit may include: a capacitor configured to accumulate the first signal in the form of voltage, and an resistor-capacitor (RC) circuit configured to implement leakage over time of the first signal accumulated in the form of voltage.

The step function may include a specific derivative value based on the membrane potential value exceeding a threshold voltage.

The first synaptic array and the second synaptic array may be stacked in a 3D structure.

The first synaptic array and the second synaptic array may be configured with heterogeneous memory elements.

The first synaptic array may include a memory element comprising a non-volatile memory (NVM), and the second synaptic array may include an analog memory element including a capacitor.

There is provided a method of operating an array system, the method including: generating a pulse of a pre-synaptic neuron among spiking neurons of a spiking neural network (SNN), processing, by first synaptic elements of a first synaptic array and based on the pulse, a first signal of the pre-synaptic neuron, storing, in second synaptic elements of a second synaptic array, a gradient transferred from a post-synaptic neuron, among the spiking neurons, generating a spike trace of the gradient and changes to the gradient over time based on the pulse, and training the SNN by a pseudo-derivative value of the gradient.

Additional aspects of example embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain example embodiments with reference to the accompanying drawings, in which:

FIG. 1A is a schematic diagram of an SNN;

FIG. 1B is a diagram illustrating a method of operating an SNN;

FIG. 1C is a diagram illustrating membrane potential attenuation of an SNN;

FIG. 1D is a roll-up diagram illustrating a process of generating data by an SNN;

FIG. 2 is a block diagram of an array system according to one or more embodiments;

FIG. 3A is a learning schematic diagram of an SNN using a second synaptic array according to one or more embodiments;

FIG. 3B is a diagram illustrating algorithms capable of performing learning using a second synaptic array according to one or more embodiments;

FIG. 4A is a conceptual diagram of arrangement of an array system according to one or more embodiments;

FIG. 4B is a diagram illustrating a configuration of an array system according to one or more embodiments;

FIG. 4C is a side view of an array system according to one or more embodiments;

FIG. 5A is a diagram illustrating a signal transmission direction of an array system according to one or more embodiments;

FIG. 5B is a diagram illustrating an operation of an array system over time according to one or more embodiments;

FIG. 6A is a diagram illustrating an operation of a peripheral circuit block according to one or more embodiments;

FIG. 6B is a diagram illustrating an example of a configuration of a spike trace circuit according to one or more embodiments;

FIG. 6C is a diagram illustrating an operation of a spike trace circuit over time according to one or more embodiments;

FIG. 7 is a diagram illustrating an operation concept of a pseudo-derivative circuit according to one or more embodiments;

FIG. 8 is a diagram illustrating a scheme of implementing a circuit of a pseudo-derivative circuit according to one or more embodiments;

FIG. 9A is a diagram illustrating a method of updating an auxiliary synaptic array using a stochastic pulse according to one or more embodiments;

FIG. 9B is a diagram illustrating a situation in which a stochastic pulse is applied to a second synaptic array according to one or more embodiments;

FIG. 10 is a diagram illustrating a structure of an array system including heterogeneous memories and a gradient transfer method according to one or more embodiments;

FIG. 11 is a diagram illustrating an example of a structure of an array system including three-dimensional (3D) heterogeneous memories according to one or more embodiments; and

FIG. 12 is a flowchart illustrating a method of operating an array system according to one or more embodiments.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is "connected," "coupled," or "joined" to another component, a third component may be "connected," "coupled," and "joined" between the first and second components, although the first component may be directly connected, coupled, or joined to the second component.

As used herein, the singular form is intended to include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

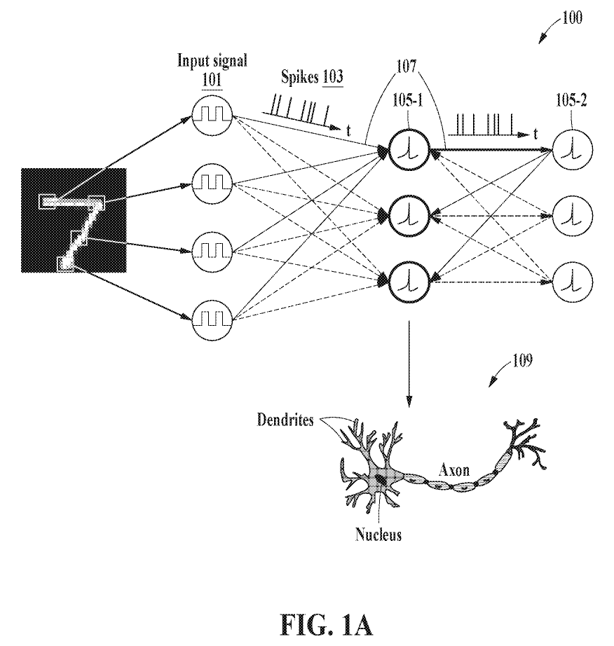

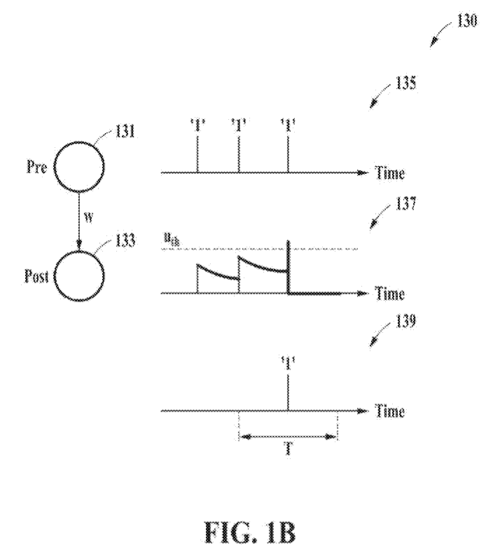

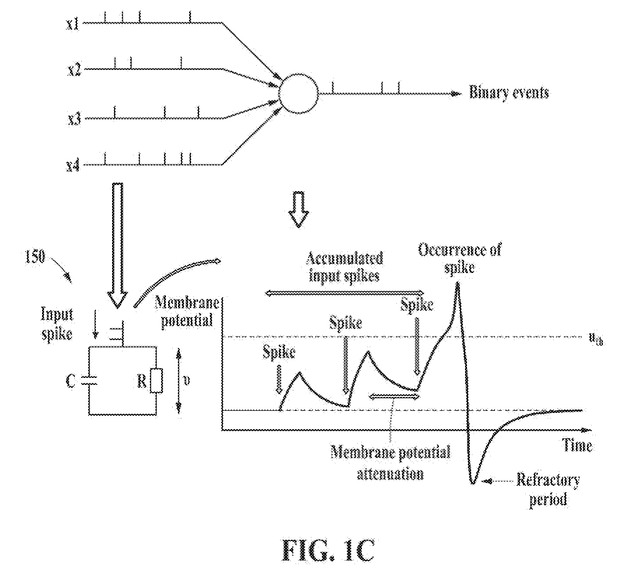

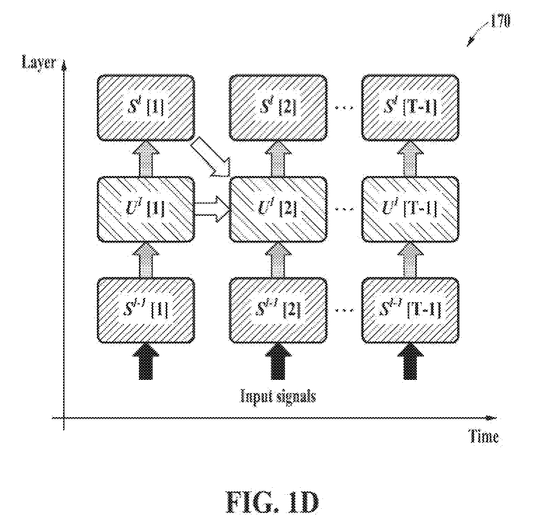

FIG. 1A is a schematic diagram of an SNN. Referring to FIG. 1A, an example of a structure of an SNN is illustrated.

An SNN 100 may transmit a signal based on one or more spikes 103 by mimicking a biological neuron 109. The SNN 100 may include a first neuron 105-1 and a second neuron 105-2 and synapses 107. The first neuron 105-1 and the second neuron 105-2 are the basic units of the SNN 100 and may receive and accumulate input signals 101. The first neuron 105-1 and the second neuron 105-2 may fire the one or more spikes 103 when the accumulated signal exceeds a specific threshold value. For example, the one or more spikes 103 fired from the first neuron 105-1 may be transferred to the second neuron 105-2 through the synapse 107. The first neuron 105-1 may correspond to a pre-synaptic neuron 131 illustrated in FIG. 1B to be described below, and the second neuron 105-2 may correspond to a post-synaptic neuron 133 illustrated in FIG. 1B to be described below.

The synapse 107 is responsible for connections between the first neuron 105-1 and the second neuron 105-2 and may correspond to a path through which the one or more spikes 103 are transferred. The strength of the synapse 107 may be adjusted through a learning algorithm. The strength of synapse 107 may improve the performance of the SNN 100.

The SNN 100 may analyze a pattern of the input signals 101 over time, which may be advantageous for real-time signal processing.

FIG. 1B is a diagram illustrating a method of operating an SNN. Referring to FIG. 1B, a diagram 130 is illustrated to describe an information processing method in the pre-synaptic neuron 131 and the post-synaptic neuron 133 connected through a synapse (e.g., the synapse 107 of FIG. 1A).

When the pre-synaptic neuron 131 and the post-synaptic neuron 133 are connected through the synapse, the pre-synaptic neuron 131 may transfer information to the post-synaptic neuron 133. At this time, a graph 135 may show three spikes sequentially transferred by the pre-synaptic neuron 131 to the post-synaptic neuron 133 along a time axis. In addition, a graph 137 may show an action potential of the post-synaptic neuron 133 over time. In the graph 137, it may be seen that the action potential of the post-synaptic neuron 133 surges to a specific value each time it receives first and second spikes from the pre-synaptic neuron 131, and then is gradually attenuated due to leakage over time. As described above, the phenomenon in which a potential difference across cell membrane decreases as the action potential is attenuated over time due to the leakage may be referred to as "membrane potential attenuation." The membrane potential attenuation will be described in more detail with reference to FIG. 1C below.

When a third spike is transferred to the post-synaptic neuron 133 and the action potential exceeds a threshold voltage Uₜₕ shown in the graph 137, a spike '1' may occur from the post-synaptic neuron 133 as shown in a graph 139. After the spike occurs, a value of the action potential of the post-synaptic neuron 133 may be initialized to "0" as shown in the graph 137. The above-described operation may also be applied when a plurality of neurons are connected.

FIG. 1C is a diagram illustrating membrane potential attenuation of an SNN. Referring to FIG. 1C, a diagram is illustrated to describe an operation of a leaky integrate-and-fire (LIF) neuron model 150.

As described above, the SNN may include a concept of time in interactions between neurons, called neuron(s) and spikes. The SNN may change an internal state of a neuron (e.g., a post-synaptic neuron) based on temporal information and spikes transferred from another neuron (e.g., a pre-synaptic neuron), and a spike may occur when the changed internal state of the neuron (e.g., the post-synaptic neuron) satisfies specific conditions.

A neuron's nerve cell body may be separated into the inside and outside by a cell membrane, and may form a membrane potential. The cell membrane may be modeled as the LIF neuron model 150 as shown in FIG. 1C.

The LIF neuron model 150 may model the following rules that neurons have:
1) The LIF neuron model 150 may synthesize spikes of the pre-synaptic neuron(s). At this time, the spikes of the pre-synaptic neuron(s) may be seen as externally coming power and may correspond to a power source of the neurons.
2) The LIF neuron model 150 may generate the spike when the membrane potential exceeds the threshold voltage Uₜₕ and maybe initialized to a reset voltage (e.g., 0 V). The pre-synaptic neuron of a living body may store sodium ions within the neuron through the action potential, and such a feature may be modeled as a capacitor C that temporarily stores power. Additionally, the voltage of the membrane potential may be increased by the action potential and then, over time, return to the reset voltage as ions escape through the cell membrane, and this action may be modeled as a resistor R.
Based on the above description, the LIF neuron model 150 may be implemented as an resistor–capacitor (RC) circuit. The cell membrane may be represented by the capacitor C of the RC circuit, and a potential difference between both ends of a battery may be represented by the membrane potential. When an external current I is input to the RC circuit, the capacitor C corresponding to the battery may be charged.
At this time, when the pre-synaptic neurons receive input spikes and the action potential (the membrane potential) of the post-synaptic neurons exceeds the threshold voltage Uₜₕ as the input spikes are accumulated, the post-synaptic neurons may generate output spikes.
3) In the LIF neuron model 150, a membrane potential voltage may continuously leak.

FIG. 1D is a roll-up diagram illustrating a process of generating data by an SNN. Referring to FIG. 1D, a roll-up diagram 170 for a case where data generation (e.g., inference) is performed through a forward propagation operation in the SNN is illustrated.

According to the roll-up diagram 170, the SNN may calculate a loss for all time steps during the forward propagation, and perform backward propagation for a spatiotemporal loss at a last time step among given time steps.

To represent the activity of pre-synaptic neurons in hardware, for example, a current-based LIF neuron model 150 such as that illustrated in FIG. 1C may be used.

The activity of the pre-synaptic neurons may be expressed in terms of the computation of an eligible trace and an eligible spike. The "eligible trace" may correspond to a value indicating a possibility of a weight change at a specific synapse during learning. The eligible trace may trace a period of time during which the synaptic weight may change after a neuron fires a spike. In one or more embodiments, a combination of the eligible trace and a reward signal (or an error signal) may be used to update the synaptic weight. In other words, a product of the eligible trace and the reward signal may be a gradient for the synaptic weight. More specifically, the eligible trace may change the record of previous states of neurons into information that may be referenced in the current state.

Specifically, the eligible trace is a value calculated for each type step at each synapse, and may be expressed as the product of a pseudo-derivative using the spike trace of the pre-synaptic neuron of each synapse and the membrane potential of the post-synaptic neuron.

The algorithm of using the eligible trace is an algorithm that approximates and adjusts a weight gradient over time, that is, a temporal gradient to perform calculation in the forward propagation process, and may use the trace of signals of the pre-synaptic neuron and the post-synaptic neuron. A weight update rule using the eligible trace may be formed of the product of the spike trace of the pre-synaptic neuron, the membrane potential of the post-synaptic neuron, and the learning signal. The "spike trace" may also be called "spike track."

By the eligible trace, the temporal gradient may be expressed as spatial information or a trace value that may be referenced at that time. This may imply that the amount of computation along the time axis does not increase as the time step increases, or in other words, the time complexity is independent of the time step.

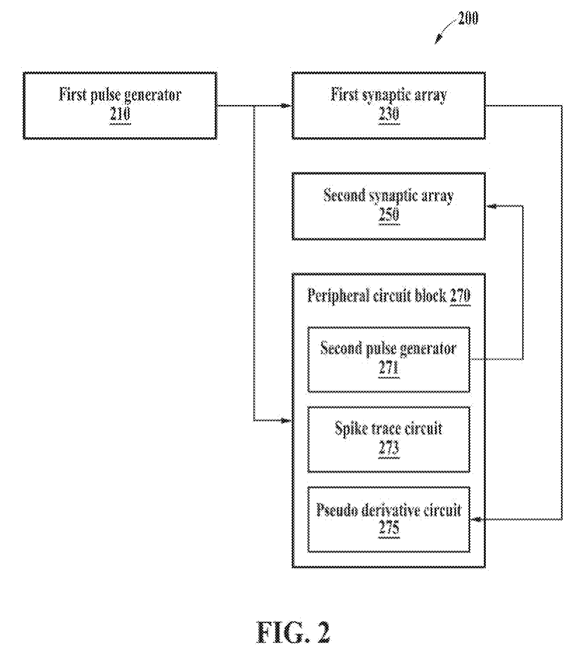

FIG. 2 is a block diagram of an array system according to one or more embodiments. Referring to FIG. 2, an array system 200 according to one or more embodiments includes a first pulse generator 210, a first synaptic array 230, a second synaptic array 250, and a peripheral circuit block 270.

The array system 200 may correspond to an array system for learning an online SNN using the eligible trace. The array system 200 may include a memory device including the first synaptic array 230 and the second synaptic array 250, and a driving device (e.g., the peripheral circuit block 270) for driving the memory device.

In one or more embodiments, heterogeneous synaptic arrays (e.g., the first synaptic array 230 and the second synaptic array 250) are used for efficient configuration of the memory device and the driving device for learning of the SNN, thereby alleviating the problem caused by the non-ideality of the array elements. In one or more embodiments, the learning of the SNN may be effectively implemented through the second synaptic array 250.

The array system 200 may train the SNN by storing the gradient that is accumulated over time using the second synaptic array 250, and transferring the stored gradient to the first synaptic array 230 according to a specific signal. The "gradient" is a value that represents a rate of change of a loss function during the learning process of a neural network, and may play an important role in updating the weights of the neural network. In traditional neural networks, the gradient is calculated using continuous values, but in the SNN, the gradient calculation may be more complex because spike events are discrete.

In the SNN, the gradient may be calculated, for example, by backpropagation, spike-timing-dependent plasticity (STDP), and/or surrogate gradient methods, but the gradient calculation is not necessarily limited thereto. The backpropagation method is a modified method of the backpropagation algorithm used in traditional neural networks, applied to the SNN, and may update weights by calculating the gradient of the loss function. The STDP method may calculate the gradient by adjusting synaptic weights according to a spike timing difference between neurons. The surrogate gradient method may use continuous surrogate gradients to overcome the discontinuity of spike events.

The array system 200 may store the gradient operation result using a signal generated from the peripheral circuit block 270 in the second synaptic array 250 by using the first pulse generator 210.

The first pulse generator 210 generates a pulse corresponding to a pre-synaptic neuron among spiking neurons of the SNN. The spike from the pre-synaptic neurons may be input to a spike trace circuit 273. A signal (spike trace) output from the spike trace circuit 273 may function as a signal that accumulates and leaks spike information. The spike trace may have the form of a vector with the same number of elements as, for example, the pre-synaptic neurons.

The first synaptic array 230 includes first synaptic elements that process a first signal corresponding to the pre-synaptic neuron based on a pulse generated by the first pulse generator 210. The pre-synaptic neuron may correspond to a neuron that fires spikes, or in other words, a spiking neuron. The first synaptic elements of the first synaptic array 230 may represent synapses, which represent connectivity between neurons, while the second synaptic elements of the second synaptic array 250 may store accumulated learning signals (e.g., gradient signals). Therefore, during the operation of the SNN, the first synaptic elements may be used in the process of processing the data applied at each time step and making inference through it. The first synaptic array 230 may also be called a "main synaptic array" as it is used in the inference process. Additionally, the second synaptic array 250 may also be called an "auxiliary synaptic array" as it is used to store the gradients for the learning process.

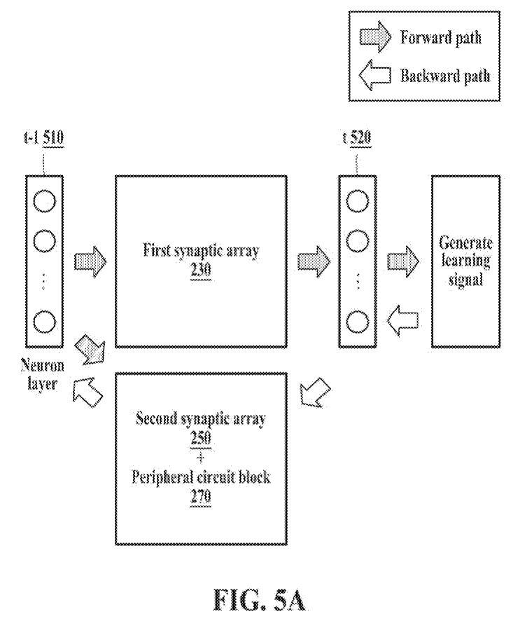

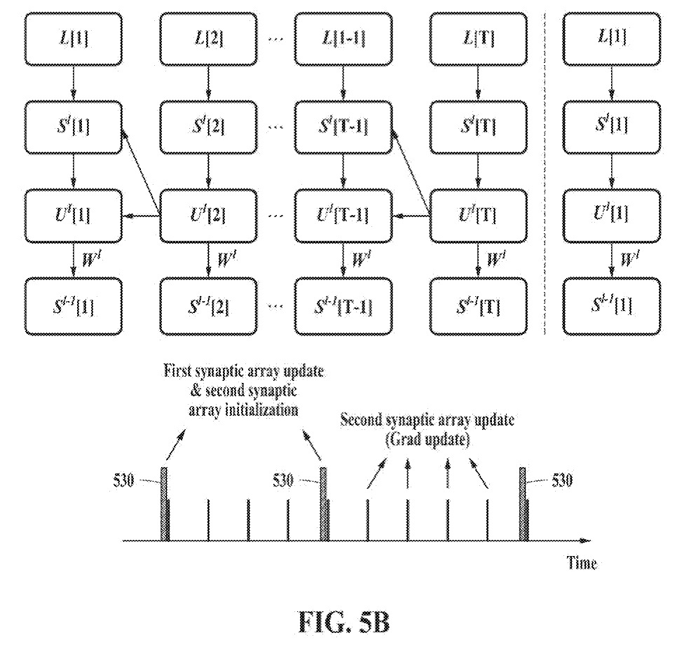

When a learning signal is generated in an external circuit by a difference between the result of inference and a correct answer, the gradient using the difference between the result of inference and the correct answer may be stored in the second synaptic array 250. As will be described in more detail with reference to FIG. 5B below, the update of the second synaptic array 250 may be performed a plurality of times, and each time an episode ends, the gradient stored in the second synaptic array 250 may be transferred to the first synaptic array 230. At this time, one episode may correspond to, for example, a period of time taken from the start to the end of an event such as processing of one image or a game, but is not necessarily limited thereto.

The first synaptic array 230 may input a current value based on the weights stored in the first synaptic elements to the post-synaptic neuron by a pulse (or a spike) generated by the first pulse generator 210. The first synaptic array 230 may be updated as one learning episode ends.

The second synaptic array 250 includes second synaptic elements that store gradients transferred from the post-synaptic neuron among the spiking neurons. For the post-synaptic neuron, a membrane potential value of each neuron may serve as an input signal for a pseudo-derivative circuit 275. The pseudo-derivative circuit 275 may calculate a pseudo-derivative value by using the membrane potential value accumulated in the post-synaptic neuron. An output signal of the pseudo-derivative circuit 275 may be calculated by being combined with a learning signal generated from a next layer of the neuron circuit or an external circuit. The second synaptic array 250 may transfer the gradient stored in the second synaptic elements to the first synaptic elements as one learning episode ends. The second synaptic array 250 may transfer the gradient to the first synaptic elements and then initialize the values of the gradient stored in the second synaptic elements. The first synaptic elements and the second synaptic elements may include analog synapses.

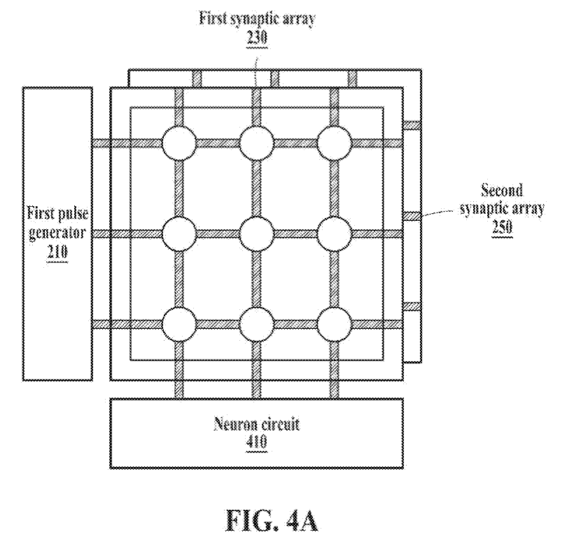

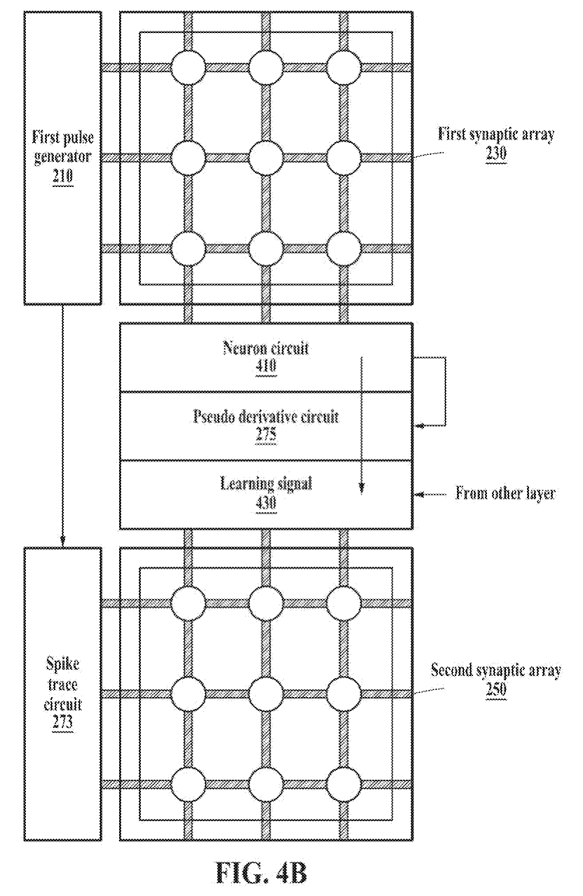

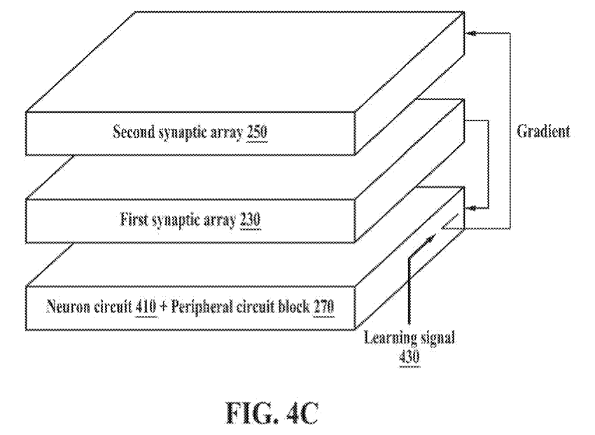

The first synaptic array 230 and the second synaptic array 250 may have the same size and may operate using the spikes output from the same spiking neuron. The first synaptic array 230 and the second synaptic array 250 may be stacked in a three-dimensional (3D) structure, for example, as shown in FIG. 4C below.

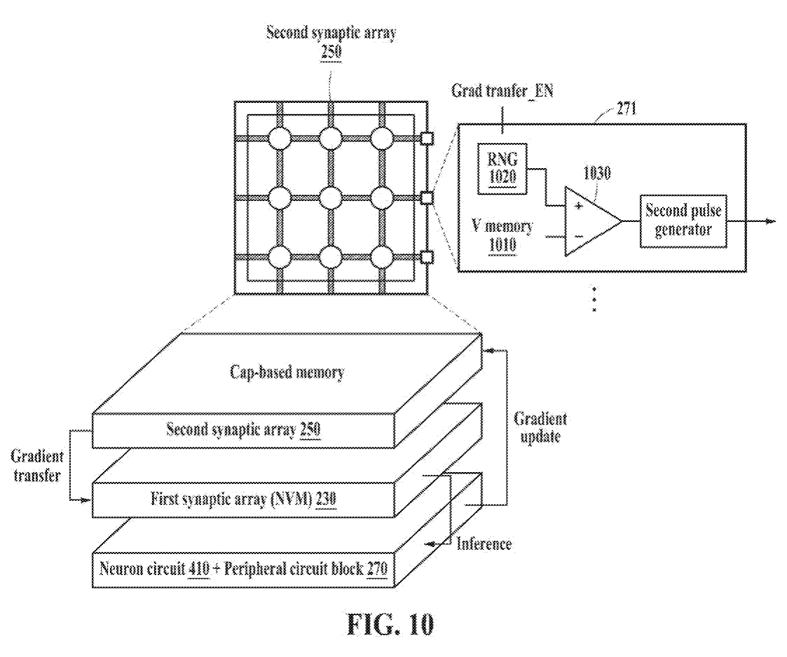

The first synaptic array 230 and the second synaptic array 250 may be formed of heterogeneous memory elements. For example, as illustrated in FIG. 10 below, the first synaptic array 230 may include a non-volatile memory (NVM)-based memory element, and the second synaptic array 250 may include a capacitor-based analog memory element.

The peripheral circuit block 270 may perform the weight update on the second synaptic array using the spike trace described above and the pseudo-derivative value for calculating the gradient for the spike, based on the pulse generated by the first pulse generator 210. The pseudo-derivative value may be an element for approximating the spike gradient in real time from the membrane potential information. The pseudo-derivative value may be used in the weight update rule described above. Here, the "weight update rule" may correspond to a rule used to update the weight of a neural network (e.g., the SNN). The weight update may be performed, for example, using the product of the spike trace of the pre-synaptic neuron, the membrane potentials of the post-synaptic neuron, and the learning signal as described above.

The second synaptic array 250 and the peripheral circuit block 270 may be used for learning using an eligible trace algorithm. The eligible trace algorithm is an algorithm that approximates and adjusts a temporal gradient to perform calculation in the forward propagation process, and may use the trace of signals of pre- and post-neurons of synapse, in other words, the pre-synaptic neuron and the post-synaptic neuron. The eligible trace is useful for tracing local events of the neurons and calculating the gradient without time evolution. However, when implementing the eligible trace digitally, cross-bar array (CBA) compatibility may be an issue and/or a large number of look-up tables (LUTs) or complex calculations may need to be performed.

When the eligible trace is implemented in a general von-Neumann computing structure, a bottleneck in data communication may occur, and energy and time inefficiencies may occur in the matrix-vector multiply (MVM) operation, which accounts for most of the artificial intelligence (AI) operations. Also, implementing the operation of a peripheral circuit over time (e.g., leakage or decay) may require a large number of look-up tables (LUTs) or complex computations.

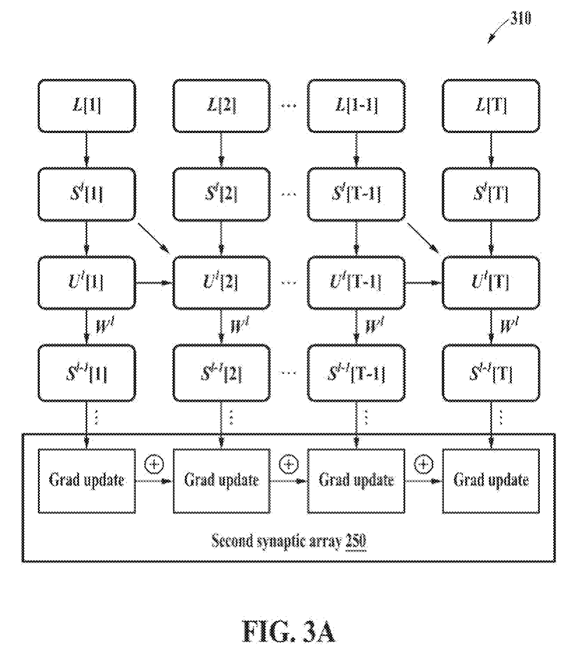

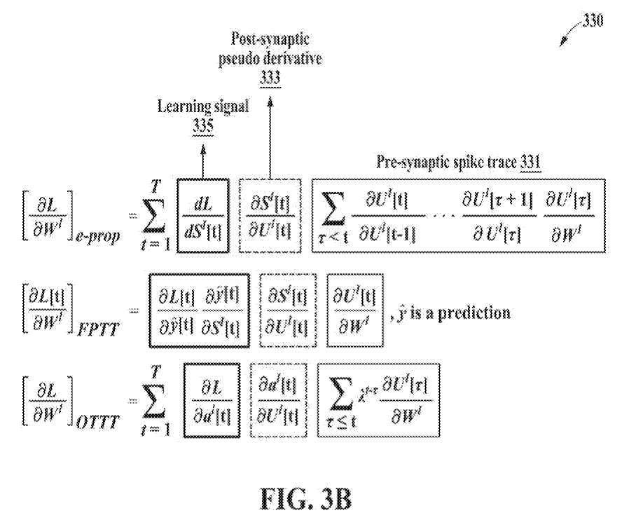

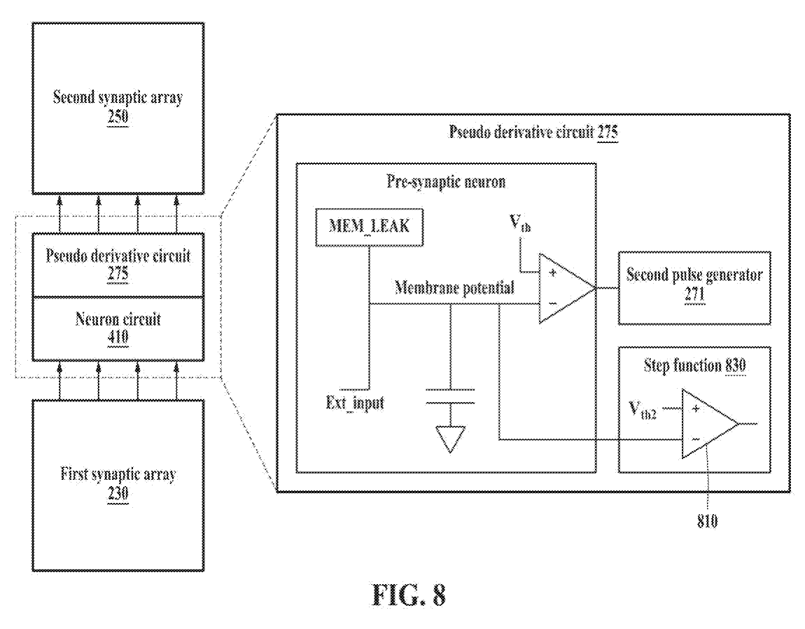

In one or more embodiments, the above-described problem may be solved by utilizing a learning structure that utilizes the eligible trace in an analog synaptic array (e.g., the first synaptic array 230 and the second synaptic array 250) and the peripheral circuit block 270. The learning structure utilizing the eligible trace will be described in more detail with reference to not only FIG. 2 but also a schematic view of FIG. 3A below and FIGS. 4, 8,9, and 10, for implementing the concept.

The peripheral circuit block 270 may update the second synaptic array 250 at each time step, or may update the second synaptic array 250 in response to the learning signal transferred through a backward pass.

The peripheral circuit block 270 may trace the spike traces to compute temporal spike information generated from the pre-synaptic neuron. The "spike trace" may be information at the current time expressed by accumulating and attenuating spike records of the neurons from the previous time. The spike trace may contain a pattern of spikes generated by a neuron at a specific time point, and the pattern may be determined by various biological processes related to the membrane potential of the neuron and a circuit that mimics them. The spike trace may play an important role in analyzing learning and information processing of a neural network at the previous time.

The peripheral circuit block 270 may calculate an eligible trace value corresponding to an outer product between the first signal of the pre-synaptic neuron and a second signal of the post-synaptic neuron. The peripheral circuit block 270 may train the SNN using the eligible trace value.

The peripheral circuit block 270 may calculate an eligible trace value by a product between the spike trace storing activation information of the pre-synaptic neuron and the pseudo-derivative value obtained by differentiating the second signal of the post-synaptic neuron with a membrane potential value accumulated in the post-synaptic neuron. The peripheral circuit block 270 may use the product between the pre-synaptic spike trace, which accumulates the spikes of the pre-synaptic neuron, and the pseudo-derivative value of the post-synaptic neuron, obtained by differentiating the spike of the post-synaptic neuron with the membrane potential value, to calculate the eligible trace value.

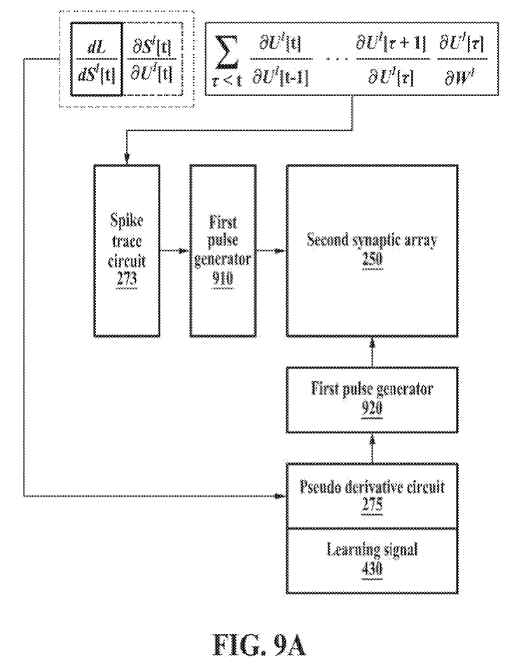

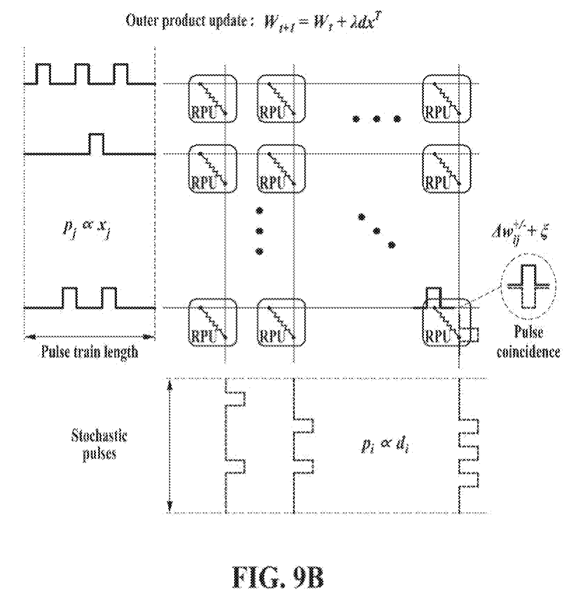

The peripheral circuit block 270 may convert the first signal and the second signal using, for example, stochastic pulses as shown in FIG. 9B below, and update the second synaptic array 250 according to whether there is a pulse coincidence between the changed first signal and the converted second signal.

The peripheral circuit block 270 may update the second synaptic array 250 by switching based on the product between the learning signal and the pseudo-derivative value for the post-synaptic neuron.

The peripheral circuit block 270 may include, for example, at least one of a second pulse generator 271, the spike trace circuit 273, and the pseudo-derivative circuit 275.

The second pulse generator 271 may generate a stochastic pulse to update the gradient in the second synaptic elements. The second pulse generator 271 may include, for example, a random number generator (RNG) 1020 and a comparator 1030 as illustrated in FIG. 10. The RNG may generate a random number. The comparator may compare the random number generated by the RNG with a voltage value stored in the second synaptic array 250. When the voltage value stored in the second synaptic array 250 is greater than the random number, the second pulse generator 271 may generate a stochastic pulse. The stochastic pulse may be used in gradient transfer from the second synaptic array 250 to the first synaptic array 230.

In one or more embodiments, when performing the computation by adding the second synaptic array 250 in addition to the first synaptic array 230, efficiency in terms of computation speed and energy may be improved since a controller or a router for transmitting signals is not required.

The second pulse generator 271 may convert the spike trace and the product between the pseudo-derivative value and the learning signal into the stochastic pulse.

The spike trace circuit 273 may accumulate the first signal in the form of a voltage, and generate a spike trace that implements the leakage of the first signal accumulated in the form of a voltage.

The spike trace circuit 273 may correspond to a circuit that leaks and/or accumulates spikes corresponding to the output of the neuron circuit. The spike trace circuit 273 may be formed of a capacitor that accumulates a spike ("first signal") in the form of a voltage, and a leakage circuit that implements leakage according to the passage of time of the first signal accumulated in the form of a voltage. The leakage circuit may be implemented in various methods other than the RC circuit that implements the LIF neuron model. However, the same leak constant as the neuron may be implemented using the same circuit as the neuron that generates the spike. In addition, since the spike trace circuit 273 reflects spike information up to the time step before the spike to the second synaptic array 250, it may include a spike buffer to hold the spike information for one time step.

The pseudo-derivative circuit 275 may implement the pseudo-derivative value calculated based on the membrane potential value accumulated in the post-synaptic neuron, for example, in the form of a step function 830 as illustrated in FIG. 8. In one or more embodiments, the complex differentiation process required in the post-neuron end may be simplified by using the pseudo-derivative circuit 275, thereby improving a response speed of the array system 200 and simplifying the system structure of the array system 200. The pseudo-derivative circuit 275 may convert the membrane potential value into the step function 830 using a comparator 810 illustrated in FIG. 8.

The post-synaptic neuron may use the information of the spike information differentiated with respect to the membrane potential. However, since the spike information is in the form of a delta function that is not differentiable with respect to the membrane potential, the derivative value that replaces the spike information may be called a pseudo-derivative value. In one or more embodiments, when the membrane potential value exceeds a specific threshold value ("threshold voltage"), a step function may be used to have a specific derivative value (e.g., a derivative value of "1"). In one or more embodiments, by using the step function, the multiplication operation between a learning signal or a global learning signal transmitted from the surrounding layer and the pseudo-derivative value may be simplified in the form of a switch.

The array system 200 according to one or more embodiments may have an analog synaptic array structure that stores a gradient accumulated over time using the second synaptic array 250, and transfers the stored gradient to the first synaptic array 230 for each specific trigger. The array system 200 may calculate a local gradient based on the activity of the pre-synaptic neuron and the post-synaptic neuron based on the eligible trace, and update the second synaptic array 250. The array system 200 may increase the efficiency of power consumption and array area by allowing the first synaptic array 230 and the second synaptic array 250 to share the same neuron circuit and utilize the peripheral circuit block 270.

FIG. 3A is a learning schematic diagram of an SNN using a second synaptic array according to one or more embodiments. Referring to FIG. 3A, a roll-up diagram 310 of an eligible trace-based SNN according to one or more embodiments illustrates that the gradient calculated at each time step is stored in the second synaptic array 250. In FIG. 3A, L[T] may represent a loss calculated using a difference between an output of a last layer and a correct answer, Sl [T] may represent a spike corresponding to a first layer, and Ul [T] may represent a membrane potential value corresponding to the first layer.

The second synaptic array (e.g., the second synaptic array 250 of FIG. 2) is an auxiliary synaptic array based on an analog signal, and may store the gradient generated at each simulation stage, transfer the stored gradient to the first synaptic array (e.g., the first synaptic array 230 of FIG. 2) at specific time intervals, and then initialize the stored gradient.

The array system may update the value of the second synaptic array 250 four times for each time step (e.g., T = 4). At this time, an input for the second synaptic array 250 may be a spike trace generated from the auxiliary circuit and a pseudo-derivative value, and an output may be a weight gradient value stored in the second synaptic array.

The array system may add a value of the second synaptic array 250 to an existing value of the first synaptic array 230 using the components shown in FIG. 2.

In one or more embodiments, the amount of computation and data transfer may be reduced by computing the eligible trace, which is the product of the activities of pre- and post-synaptic neurons, at the local level, and updating the gradient to the second synaptic array 250. This structure may be commonly used to implement the eligible trace algorithm.

FIG. 3B is a diagram illustrating algorithms capable of performing learning using a second synaptic array according to one or more embodiments. Referring to FIG. 3B, a drawing 330 illustrates common elements of learning rules in learning algorithms proposed to replace the backpropagation through time (BPTT) algorithm.

The learning rules of various learning algorithms proposed to replace the BPTT algorithm, which generally learns using backpropagation in the SNN, may determine a how much the synaptic connection strength is to be adjusted when a learning signal 335 is transmitted to each synapse by commonly using the signals of the pre-synaptic neuron and the post-synaptic neuron. The learning signal 335 may be input from an external circuit.

At this time, the learning rules may use the product between a pre-synaptic spike trace 331, which accumulates the spikes of the pre-synaptic neuron and a post-synaptic pseudo-derivative value 333, which differentiates the spikes of the post-synaptic neuron with the membrane potential, together with the learning signal 335, for the calculation of the eligible trace. The post-synaptic pseudo-derivative value 333 may refer to a gradient value using the membrane potential in a next layer. Also, the pre-synaptic spike trace 331 may correspond to records of spikes occurring in a previous layer. At this time, the pre-synaptic spike trace 331 may include attenuation according to a signal.

At this time, an outer product of two vectors formed of the signals of the pre-synaptic neuron and the post-synaptic neuron to calculate the eligible trace for all synapses.

FIG. 4A is a conceptual diagram of arrangement of an array system according to one or more embodiments, FIG. 4B is a diagram illustrating a configuration of an array system according to one or more embodiments, and FIG. 4C is a side view of an array system according to one or more embodiments.

The first synaptic array 230 and the second synaptic array 250 of the array system according to one or more embodiments use the signals from the same neuron circuit 410, and may thus be disposed in structurally close positions, for example, as shown in FIG. 4A.

Referring to FIG. 4A, the first pulse generator 210 that generates a pulse (spike) transferred from the pre-synaptic neuron may be disposed on a word line (WL) on the left side of the first synaptic array 230, and the neuron circuit 410 corresponding to the post-synaptic neuron circuit may be disposed on a bit line (BL) on the lower side of the first synaptic array 230.

Referring to FIG. 4B, a connection structure between the components of the peripheral circuit block 270 and the second synaptic array 250 for the learning using the eligible trace is illustrated. The spike of the pre-synaptic neuron generated by the first pulse generator 210 may act as an input signal of the spike trace circuit 273, and an output of the spike trace circuit 273 may act as a signal that accumulates and leaks the spike information.

In the case of the post-synaptic neuron (the neuron circuit 410), the membrane potential value of each neuron may act as an input signal of the pseudo-derivative circuit 275. The output signal of the pseudo-derivative circuit 275 may be calculated by combining it with a learning signal 430 generated in a next layer or an external circuit.

Referring to FIG. 4C, a structure according to one or more embodiments in which an analog synaptic array including the first synaptic array 230 and the second synaptic array 250 and the peripheral circuit block 270 including the neuron circuit 410 are three-dimensionally stacked is illustrated.

The first synaptic array 230 and the second synaptic array 250 may store the gradient corresponding to each synapse. The first synaptic array 230 and the second synaptic array 250 are arrays of the same size and may be structurally adjacent because it is necessary to perform operations using a pre-synaptic signal and a post-synaptic signal. In one or more embodiments, a neuromorphic neural network that operates with high integration and high efficiency may be implemented through a three-dimensionally stacked structure.

FIG. 5A is a diagram illustrating a signal transmission direction of an array system according to one or more embodiments, and FIG. 5B is a diagram illustrating an operation of an array system over time according to one or more embodiments.

Referring to FIG. 5A, the first synaptic array 230 may represent a synapse that refers to connectivity between neuron layers (e.g., a (t-1) layer 510 and a t layer 520). In contrast, the second synaptic array 250 may store the accumulated learning signal (e.g., the gradient).

Therefore, during the operation of the SNN, the first synaptic array 230 may be used in the forward path that processes the data applied at each time step and makes the inference through it. At this time, when the learning signal is generated by the difference between the result of the inference and the correct answer, the gradient used as the learning signal may be stored in the second synaptic array 250 through the backward path.

At this time, as illustrated in FIG. 5B, the gradient may be updated in the second synaptic array 250 at each time step or each time when the learning signal is generated. The update results of the second synaptic array 250 may be stored over the plurality of time steps. The gradient stored in the second synaptic array 250 may be transferred to the first synaptic array 230 each time when one episode ends (at time 530).

When one episode ends (at time 530), the gradient stored in the second synaptic array 250 may be added to the first synaptic array 230, and at the same time, the gradient value of the second synaptic array 250 may be initialized to "0."

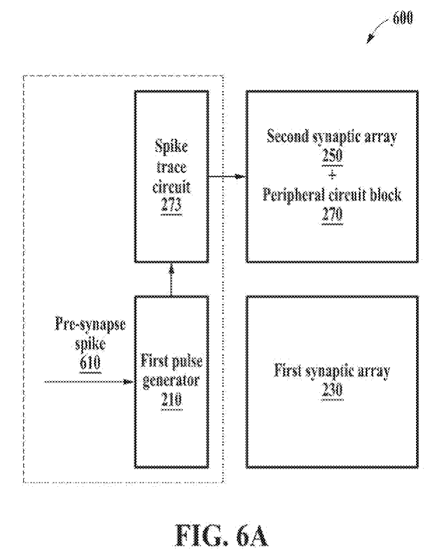

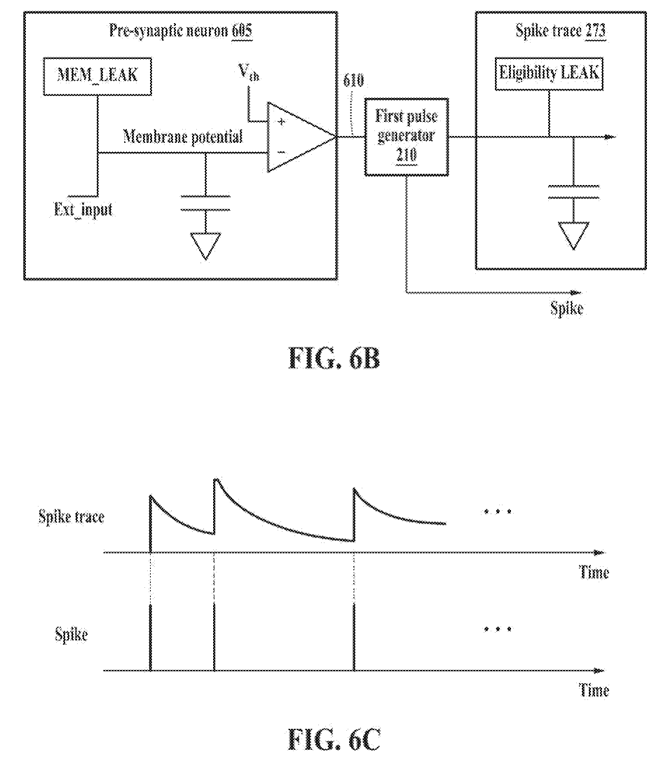

FIG. 6A is a diagram illustrating an operation of a peripheral circuit block according to one or more embodiments, and FIG. 6B is a diagram illustrating an example of a configuration of a spike trace circuit according to one or more embodiments. FIG. 6C is a diagram illustrating an operation of a spike trace circuit over time according to one or more embodiments.

Referring to FIGS. 6A and 6B , the spike trace circuit 273 for implementing the spike trace for a pre-synaptic neuron circuit 605 according to one or more embodiments is illustrated.

The spike trace circuit 273 may trace by leaking and accumulating spikes 610 that fire in the pre-synaptic neuron circuit 605. The spike trace circuit 273 may play a role in accumulating the spikes 610 based on a capacitor and gradually reducing (attenuating) the accumulated spikes over time due to leakage of the RC circuit. The spike trace circuit 273 may include, for example, a capacitor for accumulating the spikes 610 in the form of a voltage, and a leakage circuit for allowing the accumulated voltage to leak over time. The leakage circuit may be implemented in a variety of ways to implement each LIF neuron. The leakage circuit may implement the same leak constant (e.g. eligibility LEAK) as a neuron by using the same circuit as the neuron that generates the spike 610.

In addition, the spike trace circuit 273 may be used in the second synaptic array 250 to reflect the accumulation and leakage of spike information up to the time step before the spikes 610 occur, as shown in FIG. 6C. Therefore, the spike trace circuit 273 may include a buffer (e.g., a spike buffer) within the circuit to hold the spike information for one time step.

In order to calculate the gradient, elements that decay in the membrane potential needs to be reflected, as in FIG. 6C, and this decay may be expressed as the pre-synaptic spike trace 331 in the mathematical equation described above with reference to FIG. 3B.

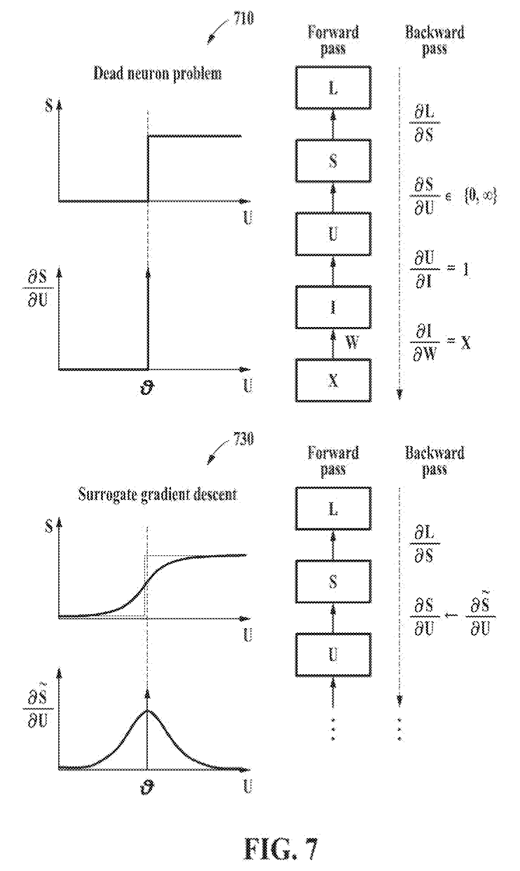

FIG. 7 is a diagram illustrating an operation concept of a pseudo-derivative circuit according to one or more embodiments.

In the post-synaptic neuron circuit as shown in a drawing 710 of FIG. 7, spikes may occur discontinuously. In this case, the spike is in the form of a delta function that is not differentiable with respect to the membrane potential, so it is not differentiable, and therefore the transmission of the learning signal may not be possible.

In one or more embodiments, to solve the impossibility of differentiating the spike, a derivative value of the spike may be replaced by a function that changes according to the membrane potential value, as shown in a drawing 730 of FIG. 7, and the value replacing the derivative value of the spike may be called a "pseudo-derivative value."

There may be various methods of implementing the pseudo-derivative value, and in one or more embodiments, the pseudo-derivative value may be implemented using a step function as shown in FIG. 8 below.

FIG. 8 is a diagram illustrating a scheme of implementing a pseudo-derivative circuit according to one or more embodiments. Referring to FIG. 8, a pseudo-derivative circuit 275 and the neuron circuit (e.g., the pre-synaptic neuron circuit) 410 disposed between the first synaptic array 230 and the second synaptic array 250 according to one or more embodiments are illustrated.

A value calculated as a current by a weight value stored in the first synaptic array 230 may be input to the neuron circuit 410 by pulse, and accordingly, the neuron circuit 410 may calculate the membrane potential value. The pseudo-derivative circuit 275 and the neuron circuit 410 may be disposed in each layer of the neuron circuit.

The pseudo-derivative circuit 275 according to one or more embodiments may determine whether the membrane potential value exceeds a specific threshold value using the comparator 810. As the result of the comparison of the comparator 810, when the membrane potential value exceeds the specific threshold value, the pseudo-derivative circuit 275 may implement a pseudo-derivative value by using the step function 830 that has a derivative value of "1." The output of the step function 830 may be connected to the second synaptic array 250.

The pseudo-derivative circuit 275 may simplify the product operation between a local learning signal or a global learning signal transmitted to a surrounding layer and the output (pseudo-derivative value) in the form of a switch by using the step function 830. The pseudo-derivative value calculated by the pseudo-derivative circuit 275 may correspond to the post-synaptic pseudo-derivative value 333 in the mathematical equation described above with reference to FIG. 3B. At this time, the second pulse generator may be used to depict the spikes that are transmitted to the next layer.

FIG. 9A is a diagram illustrating a method of updating a second synaptic array using a stochastic pulse according to one or more embodiments. FIG. 9B is a diagram illustrating a situation in which a stochastic pulse is applied to a second synaptic array according to one or more embodiments.

Referring to FIGS. 9A and 9B , a connection structure between components of the peripheral circuit blocks and the second synaptic array 250 according to one or more embodiments is illustrated.

In one or more embodiments, the second synaptic array 250 may be updated by first pulse generator 910 and first pulse generator 920 that generate stochastic pulses for updating the gradient.

At an input terminal of the second synaptic array 250, a spike trace vector output from the spike trace circuit 273 may be converted into a stochastic pulse through the first pulse generator 910. In addition, at an output terminal of the second synaptic array 250, the product between the learning signal 430 and the pseudo-derivative value output from the pseudo-derivative circuit 275 may be converted into the stochastic pulse through the first pulse generator 920.

The stochastic pulses are simultaneously applied to the input and output terminals of the second synaptic array 250 through the first pulse generator 910 and the first pulse generator 920, and when the two pulses overlap, a weight update may occur. Therefore, the weight update proportional to the product of signals applied to the input and output terminals of the second synaptic array 250 may occur.

The array system according to one or more embodiments may train the second synaptic array 250 using the product between spikes occurring in the pre-synaptic neuron circuit and spikes occurring in the post-synaptic neuron circuit. At this time, the spike occurring in the pre-synaptic neuron circuit may be generated by the first pulse generator 910, and the spike occurring in the post-synaptic neuron circuit may be generated by the first pulse generator 920.

The array system may convert each spike into stochastic pulses by the first pulse generator 910 and the first pulse generator 920. At this time, when synapse update is set to occur by pulse coincidence, the second synaptic array 250 may be updated in proportion to the product of the two values.

In one or more embodiments, the complexity of performing the multiplication of any two voltages may be simplified by changing a product signal between the learning signal and the pseudo-derivative value used in the post-synaptic neuron circuit to a switch through the simplification of the pseudo-derivative circuit described above with reference to FIG. 8.

FIG. 10 is a diagram illustrating a structure of an array system including heterogeneous memories and a gradient transfer method according to one or more embodiments. Referring to FIG. 10, in one or more embodiments, an array system may be configured with a 3D stacking structure using the heterogeneous memory for efficient hardware implementation.

In one or more embodiments, the first synaptic array 230 and the second synaptic array 250 are configured as a 3D stacking type memory, thereby enabling the first synaptic array 230 and the second synaptic array 250 to efficiently receive signals from the same pre-synaptic neuron and post-synaptic neuron.

As described above, the first synaptic array 230 and the second synaptic array 250 need to be physically attached and have the same size, and therefore, the stacking the first synaptic array 230 and the second synaptic array 250 in a 3D structure may be advantageous. At this time, the first synaptic array 230 is used for inference purposes, and thus, it may include a memory element based on NVM with a value that does not change over time. In addition, since the second synaptic array 250 is important for accurate gradient storage, it may include an analog memory element of a capacitor with good linear characteristics, such as a 2T (transistor) - 1C (capacitor) memory or a 6T - 1C memory.

In addition, the array system may directly convert a voltage value 1010 stored in the second synaptic array 250 into a stochastic pulse using the RNG 1020 and the comparator 1030 in the peripheral circuit block 270 including the neuron circuit 410. The array system may convert the voltage value 1010 into the stochastic pulse when the voltage value 1010 stored in the second synaptic array 250 is greater than a value generated by the RNG 1020. The array system may generate the stochastic pulse proportional to the voltage value 1010 stored in the second synaptic array 250. The stochastic pulse may be used to transfer gradients from the second synaptic array 250 to the first synaptic array 230.

In one or more embodiments, by adding the second synaptic array 250, efficiency in terms of computation speed and energy may be increased because a separate controller or router for transmitting signals is not required for computation.

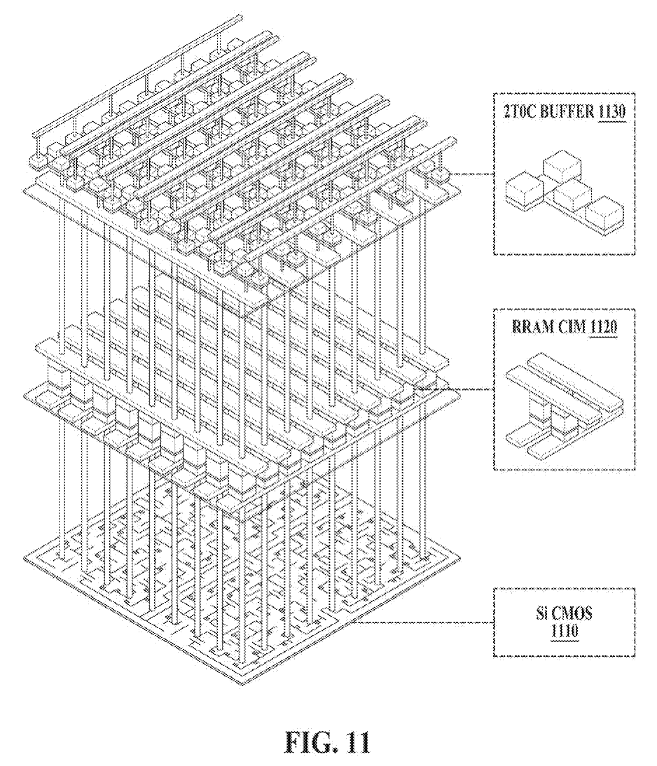

FIG. 11 is a diagram illustrating an example of a structure of an array system including 3D heterogeneous memories according to one or more embodiments.

Referring to FIG. 11, the array system according to one or more embodiments may be configured with a three-dimensionally stacked structure of a first synaptic array formed of a CMOS type silicon (Si) memory cells 1110, a second synaptic array formed of a resistive random access memory (RRAM) computing-in-memory (CIM) 1120, and a buffer 1130 formed of 2T -0C dynamic random access memory (DRAM), but is not necessarily limited thereto.

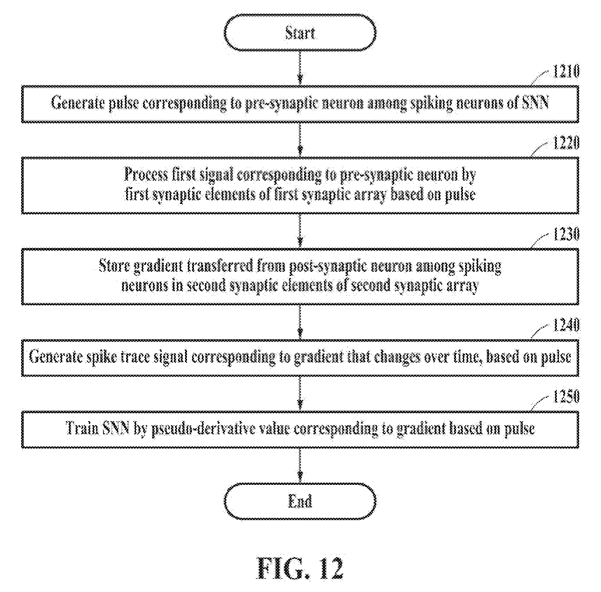

FIG. 12 is a flowchart illustrating a method of operating an array system according to one or more embodiments. Operations in the embodiment of FIG. 12 may be performed sequentially but not necessarily performed sequentially. For example, the order of the operations may change, at least two of the operations may be performed in parallel, or one operation may be split and performed.

Referring to FIG. 12, the array system according to one or more embodiments may train an SNN through operation 1210, operation 1220, operation 1230, operation 1240, to operation 1250.

In operation 1210, the array system generates a pulse corresponding to a pre-synaptic neuron among spiking neurons of an SNN.

In operation 1220, the array system processes a first signal corresponding to the pre-synaptic neuron by first synaptic elements of a first synaptic array based on the pulse generated in operation 1210.

In operation 1230, the array system stores a gradient transferred from a post-synaptic neuron among the spiking neurons in second synaptic elements of a second synaptic array.

In operation 1240, the array system generates a spike trace corresponding to the gradient that changes over time, based on the pulse generated in operation 1210.

In operation 1250, the array system may train the SNN by a pseudo-derivative value corresponding to the gradient based on the pulse generated in operation 1210.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a digital signal processor (DSP), a microcomputer, an FPGA, a programmable logic unit (PLU), a microprocessor or any other device capable of responding to and executing instructions in a defined manner. The processing device may run an OS and one or more software applications that run on the OS. The processing unit also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combinations thereof, to independently or collectively instruct or configure the processing device to operate as desired. Software and data may be embodied permanently or temporarily in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents. Therefore, other implementations, other embodiments, and equivalents to the claims are also within the scope of the following claims.

What is claimed is:

1. An array system comprising:
a first pulse generator configured to generate a pulse of a pre-synaptic neuron among spiking neurons of a spiking neural network (SNN);
a first synaptic array comprising first synaptic elements configured to process a first signal of the pre-synaptic neuron and based on the pulse;
a second synaptic array comprising second synaptic elements configured to store a gradient transferred from a post-synaptic neuron among the spiking neurons; and
a peripheral circuit block configured to generate a spike trace of the gradient and changes to the gradient over time based on the pulse, and to train the SNN by a pseudo-derivative value of the gradient.

2. The array system of claim 1, wherein the first synaptic array is configured to input a current value, based on weights stored in the first synaptic elements, to the post-synaptic neuron by the pulse.

3. The array system of claim 1, wherein the first synaptic array is updated at an end of a learning episode.

4. The array system of claim 1, wherein the second synaptic array is configured to transfer the gradient stored in the second synaptic elements to the first synaptic elements at an end of a learning episode.

5. The array system of claim 4, wherein the second synaptic array is configured to initialize, after transferring the gradient to the first synaptic elements, a value of the gradient stored in the second synaptic elements.

6. The array system of claim 1, wherein the first synaptic array and the second synaptic array comprise a same size and are configured to operate using spikes output from at least a same spiking neuron of the spiking neurons.

7. The array system of claim 1, wherein the peripheral circuit block is further configured to at least one of:
update the second synaptic array at each of a plurality of time steps, and
update the second synaptic array in response to a learning signal transferred through a backward pass.

8. The array system of claim 1, wherein the peripheral circuit block is further configured to calculate an eligible trace value of an outer product between the first signal of the pre-synaptic neuron and a second signal of the post-synaptic neuron, and to train the SNN based on the eligible trace value.

9. The array system of claim 8, wherein the peripheral circuit block is further configured to calculate the eligible trace value by a product between a spike trace value, storing activation information of the pre-synaptic neuron, and the pseudo-derivative value of the gradient, and the pseudo-derivative value of the gradient is obtained by differentiating the second signal with a membrane potential value accumulated in the post-synaptic neuron.

10. The array system of claim 9, wherein the peripheral circuit block is further configured to convert, to a converted first signal and a converted second signal respectively, the first signal and the second signal using stochastic pulses, and to update the second synaptic array according to whether there is a pulse coincidence between the converted first signal and the converted second signal.

11. The array system of claim 9, wherein the peripheral circuit block is further configured to update the second synaptic array by switching based on a product between a learning signal, of the post-synaptic neuron, and the pseudo-derivative value.

12. The array system of claim 9, wherein the peripheral circuit block comprises at least one of:
a second pulse generator configured to generate a stochastic pulse in updating the gradient in the second synaptic elements;
a spike trace circuit configured to accumulate the first signal, in a form of a voltage, and to generate the spike trace as leakage of the first signal; and
a pseudo-derivative circuit configured to implement the pseudo-derivative value, as based on the membrane potential value accumulated in the post-synaptic neuron, in a form of a step function.

13. The array system of claim 12, wherein
the second pulse generator comprises:
a random number generator configured to generate a random number; and
a first comparator configured to compare the random number with a voltage value stored in the second synaptic array, and
based on determining that the voltage value stored in the second synaptic array is greater than the random number, the stochastic pulse is generated.

14. The array system of claim 12, wherein the second pulse generator is configured to convert the spike trace and a product, of the pseudo-derivative value and a learning signal, into the stochastic pulse.

15. The array system of claim 12, wherein the spike trace circuit comprises:
a capacitor configured to accumulate the first signal in the form of voltage; and
an resistor-capacitor (RC) circuit configured to implement leakage over time of the first signal accumulated in the form of voltage.

16. The array system of claim 12, wherein the step function comprises a specific derivative value based on the membrane potential value exceeding a threshold voltage.

17. The array system of claim 1, wherein the first synaptic array and the second synaptic array are stacked in a 3D structure.

18. The array system of claim 1, wherein the first synaptic array and the second synaptic array are configured with heterogeneous memory elements.

19. The array system of claim 18, wherein
the first synaptic array comprises a memory element comprising a non-volatile memory (NVM), and
the second synaptic array comprises an analog memory element comprising a capacitor.

20. A method of operating an array system, the method comprising:
generating a pulse of a pre-synaptic neuron among spiking neurons of a spiking neural network (SNN);
processing, by first synaptic elements of a first synaptic array and based on the pulse, a first signal of the pre-synaptic neuron;
storing, in second synaptic elements of a second synaptic array, a gradient transferred from a post-synaptic neuron, among the spiking neurons;
generating a spike trace of the gradient and changes to the gradient over time based on the pulse; and
training the SNN by a pseudo-derivative value of the gradient.
